(19) United States
(12) Patent Application Publication
(10) Pub. No.: US 2013/0332125 A1
(43) Pub. Date: Dec. 12, 2013

(54) EARTH MODEL

(71) Applicants: Erich Suter, Stavanger (NO); Eric Cayeux, Stavanger (NO)

(72) Inventors: Erich Suter, Stavanger (NO); Eric Cayeux, Stavanger (NO)

(73) Assignee: INTERNATIONAL RESEARCH INSTITUTE OF STAVANGER, Stavanger (NO)

(21) Appl. No.: 13/880,358

(22) PCT Filed: Oct. 24, 2011
(86) PCT No.: PCT/GB2011/052062

§ 371 Date: Jul. 1, 2013

(30) Foreign Application Priority Data
Oct. 22, 2010 (GB) 1017898.6

(51) Int. Cl. G01V 99/00

(52) U.S. Cl. CPC G01V 99/00
USPC 703/6

(57) ABSTRACT

An earth model comprising a plurality of regions in geological space; associated with each said region in geological space, at least one parameter function defined over a region in parameter space; associated with each region in geological space, at least one transformation which maps coordinates within the region of geological space to coordinates within the region of parameter space. This gridless approach to earth modelling allows much easier alteration of the structural model and the parameter data independently of each other, facilitating multiresolution evaluation of the model as well as easy production of multiple geological interpretations.

The invention relates to earth models, e.g. geological models for representing the sub-surface structures and properties of the earth. The invention is applicable in all areas of sub-surface modelling and exploration, including the oil, gas and thermal energy industries as well as mineral and ground water exploration.

The purpose of an earth model is to reflect the current knowledge of the subsurface in the best possible manner. The current knowledge of the subsurface is represented by actual measurements and derived information, mainly in the form of seismic and well data, as models representing the properties of the rocks, as fluid flow data and other simulation results, and as one or more geological interpretations. The interpretations are manifestations of the geological assumptions that are made, based on the available information and general geological knowledge. However, the earth model is created by applying the information known at the time of creation, and the uncertainty associated with the model is often high. When new information arrives, the uncertainty can be reduced, and the assumptions that were made during the earlier modelling stages are often modified. This results in new interpretations, often on a local scale, which it should ideally be easy to incorporate into the existing earth model. However, current earth modelling methodologies often require a complete reconstruction of the model when new information arrives, in particular if the interpretation of geological structure or the resolution of the model requires a modification. One major problem is that current models are grid based. Structural changes or resolution changes typically require re-gridding which then invalidates results of previous interpretations and simulations so that they have to be performed again based on the new grid. Rebuilding of the model therefore takes significant time.

The recently developed wired pipe technology is expected to increase telemetry rates when drilling new wells dramatically, thus offering a continuous stream of subsurface measurements which is available in real time and which must be efficiently managed. A wired pipe is capable of transmitting data at up to 10 Mbps or more (compared with the previous mud pulse telemetry rate of around 10 bps). Such systems can therefore provide a vast quantity of information to be incorporated directly into the earth model or to be used in revised interpretations of the geology. This information is highly relevant for example in geosteering applications where real time feedback provides for better decision making with regard to steering the well.

During drilling, geological structures and petrophysical and formation properties are often found to diverge from the geological interpretation represented in the earth model which was constructed prior to drilling. This comes as a result of new measurements acquired during the drilling operation, and increases the difficulty of placing the well optimally within the pay zone. Well placement decisions are made under large uncertainties, short timeframes and involve multiple objectives such as drilling risks and costs, wellbore completion configuration and future reservoir production. Real-time interpretation and modification of the existing earth model, based on data obtained during the drilling process, would be extremely useful when pursuing an optimized well placement while drilling.

However current earth modelling techniques are suboptimal in meeting today's requirements for effective model modifications during drilling and in particular geosteering. Many of the challenges are due to the grids employed by these technologies.

Earth models, for example those which represent hydrocarbon reservoir property information, often need to represent depositional layers and other geological regions, their physical properties, and the boundaries between them in the form of surfaces or other geometrical objects. Furthermore, faults resulting from tectonic activity can also be represented as surfaces. Together these surfaces constitute the structural model. This structural framework results from geological interpretation where information derives mainly from seismic data and well data in combination with general geological knowledge.

In current earth modelling methodologies, for representation of physical properties (petrophysical or formation properties, e.g. porosity, permeability, oil saturation, water saturation, lithology, density and facies type) between the surfaces in the structural model, a geological grid which embeds all surfaces is created. The geological grid may comprise several smaller grids. The generation of the grid is controlled by the surfaces in the structural model as it depends on their geometry. The standard approach, used in most industrial applications, is to utilise structured grids, for example corner-point grids. With structured grids, the resolution is specified prior to running the gridding algorithms. Great care has to be taken to specify a resolution adapted to the complexity of the model and at the same time to meet requirements for computer performance by keeping the number of grid cells as low as possible. Current applications based on such grids have only basic capabilities for generating meshes with varying resolution. Even in areas with very detailed knowledge of properties, say around a well, the grids often have a coarse resolution (compared to the resolution of the available data), dictated by the need to maintain computational performance.

The property representations are tightly linked with the grid, as one value for each property is stored in each grid cell. If the grid indexing is modified, for example when altering the number of grid cells as a result of re-gridding, the property models are invalidated. Because all properties are represented in a single grid, they are all stored at the same resolution even if the uncertainty is not equal for all properties, and even if the variation in their values cannot be well represented at the given grid resolution. Generally, there are many challenges connected with representation of properties in grids. For example, there are frequent problems with adjusting grid cells to fault geometries, in particular where faults are close or where they are densely distributed. The density and distribution of surfaces in the structural model also impacts grid resolution and geometry, and may result in a grid of denser resolution than is required to represent properties.

To overcome the problem of finding an adequate resolution for a given structural model, more recent applications have made use of unstructured grids such as PEBI grids (PErpendicular Bisector). The PEBI grid offers a greater adaptation to the stratigraphic framework. Unfortunately, it still falls short when it comes to refining the resolution around wells which are more or less parallel with the layering, which is the case with geosteering. Furthermore, they may result in approximately equal grid resolution in all spatial directions, which is often not required.

The construction of an earth model is often a highly complex, resource demanding and costly task which may take several months. Three of the most important factors are the geological complexity of the field to be modelled, the required accuracy of the geological interpretation, and how well the applied modelling tools can aid in the process. Given the amount of resources required to generate the earth model, it is clearly a large advantage if an existing model can be updated according to new information when it becomes available, rather than to reconstruct the entire model. Some of the most desirable modifications include the ability to update the structural model, for example to insert new horizons and faults or to modify or delete existing ones.

The ability to represent and extract structure and properties at various scales is also highly desirable. This factor is influenced by both geological and computer requirements. Depending on the application of the information, representation and evaluation of the model can be either on a coarse and global scale, on a finer and more local scale, or a combination. However, if the overall model resolution becomes too dense, so that there is too much information that has to be handled simultaneously, the model can no longer be effectively managed. There are two main reasons for this; the geological interpreter is forced to control more variables, and the computer performance is no longer adequate for managing the large amount of information (for example fine resolution structural grids can easily involve several million cells). An optimal representation hence includes the ability to extract the information as accurately as required, but at the same time to avoid redundant information at the scale in question. Furthermore, the models should ideally be represented at a scale adapted to the uncertainty associated with their true values. For example, when new information becomes available when drilling a new well, the uncertainty is drastically reduced along the wellbore but may be retained away from the wellbore. Thus, the resolution could be fine-scaled, depicting a low uncertainty along the wellbore, and get seamlessly coarser away from it where the uncertainty increases. This type of local scale change is to some degree available in reservoir simulators through local grid refinements (LGR) and local grid coarsenings (LGC). But LGR and LGC must currently be manually generated, and they change the scale at only one level. In current implementations it is not possible to have an LGR inside another LGR in a recursive manner. As with PEBI grids, LGR are not well suited for detailed modelling around horizontal wells because the well follows the layering.

Several applications used for three-dimensional earth modelling today rely on running a fully automatic workflow for creating and modifying the earth model. This ensures repeatability; if some parameters are modified, the model can still be automatically generated. The structural and stratigraphic models, constructed from seismic and well data, are the basis for the generation of the geological grid. As part of the workflow, the grid is created before it is populated with physical properties mainly based on well data. Some limitations of this approach are:

1) Modification of structural and stratigraphic parameters requires the entire workflow to be run again. The existing workflow-based approaches are well adapted to property modelling and sensitivity analysis of properties. However, such simulations are normally founded on a single base case interpretation of structural and stratigraphic parameters. Alteration of these parameters, triggered from new information received during drilling, often requires much manual work. Furthermore, if the property models are to be updated accordingly, a re-generation of the geological grid is required as it depends on the structural and stratigraphic models. If the adjustments are minor, for example a small modification of a surface, the grid can in some applications be modified by shifting the grid nodes in correspondence with the surface, so that the property models can be retained. However, larger modifications as for example insertion of a fault will compromise the indexing of the grid, depending on the nature of the modification, and invalidate the property models.

2) It is impossible to insert fine-scaled property information into the existing grid. When new information is received at a very fine scale along the wellbore trajectory during drilling, the derived properties can potentially be calculated at a higher resolution than dictated by the existing grid. But update of the grid resolution requires re-gridding and subsequent re-running of the workflow.

3) Invalidation of simulation results. If an existing grid is replaced by a new grid, all simulation results performed on the old grid are invalidated.

Necessary manual work, combined with computationally intensive workflow runs, can be very time-consuming and obstruct necessary model adjustments when models based on the most recent information from wells are requested. The current normal practice is that geological models are re-created for example once a year to take recently obtained information into account.

Current earth model approaches applied for geosteering where geological structure can be modified include extraction of information along the well fence (a set of vertical planes passing through the well trajectory, also called a well curtain) prior to drilling, and transfer of this information into a two-dimensional environment where model modifications can more easily be performed in real-time. Structural modifications can be performed during drilling and the well can be steered according to the new interpretation. These modifications are then included into the full three-dimensional earth model when it is reconstructed after the drilling of the well is completed. However, important information may be lost in a two-dimensional environment compared to a three-dimensional environment. This may affect the geological interpretations as well as simulations performed in the environment.

Another approach is to modify the three-dimensional structural model, potentially let the grid geometry be updated accordingly during drilling (i.e. allowing some movement of grid nodes), and run the workflow if necessary. In other words if the grid nodes have only moved a small amount, the parameter data can still be close enough to provide a useful model. However, if more complex structural changes are conducted, say the insertion of a fault, this requires construction of a new grid which respects the new structural model. Then the property models and simulation results are compromised, and a subsequent re-run of the automatic workflow for reconstruction of the models and simulations must take place. This may be too time consuming to support decisions when time is limited, for example during drilling. Therefore the grid-based methodology is challenged, in particular if more complex structural modifications are required or if a different grid resolution is requested.

For accurate modelling of the subsurface, a 3D earth model is superior to a 2D model. In the mind of the geological interpreters, geological modelling is a process that takes place in three-dimensional space. If a 2D modelling tool is used, important information is often lost, in particular in more complex fields. Ideally new data from drilling of wells should enable instantaneous and accurate geological interpretation in an environment where all available information is represented and can be efficiently accessed. Only then is it possible to evaluate the feasibility of the interpretation with respect to the rest of the model.

Furthermore, simulations are based on the geological interpretation. Most simulations should be carried out in three dimensions to include all vital information. Hence, an always up-to-date three-dimensional earth model would have the potential to allow improved real-time simulation capabilities based on the most recent knowledge of the subsurface. It is also possible that modifications to the model could be carried out without invalidating existing results from earlier time-consuming simulations. Such capabilities would provide an improved platform for the decision-making processes that take place during geosteering.

WO 2005/119304 describes a transformation based approach to earth modelling in which a grid in real space is transformed into a grid in depositional space. The effect of the transform is essentially to turn back time so as to remove any effects of tectonic activity, such as faulting or folding of the originally deposited sedimentary layers. Thus in depositional space all horizons are parallel. However the system is still grid based and data is still stored in association with grid cells. The system therefore does not avoid all the problems associated with grids. In particular the handling of large numbers of cells will still be computationally problematic. As the grid in depositional space is generated from the grid in geological space by a transformation, the cells in both spaces can have the same indexing and so parameter data corresponding to the cells can be accessed from either space. Essentially, as the transformation is applied to the grid which is inextricably linked to both the structural model and the parameter data, the transformation necessarily transforms both the structural model and the parameter data at the same time. The two cannot be separated.

According to one aspect of the invention there is provided an earth model comprising: at least one region in geological space; associated with the or each said region in geological space, at least one parameter function defined over a region in parameter space; and associated with each region in geological space, at least one transformation which maps coordinates within the region of geological space to coordinates within the region of parameter space.

According to another aspect of the invention there is provided an earth model comprising: a plurality of regions in geological space; associated with each said region in geological space, at least one parameter function defined over a region in parameter space; and associated with each region in geological space, at least one transformation which maps coordinates within the region of geological space to coordinates within the region of parameter space.

The regions used for representing parameters (properties) are located in what is denoted parameter space, i.e. a space containing parameters. It exists for mathematical convenience only, to represent the properties in an environment where they can be more efficiently managed. The region is the same as the domain for the parameter function.

In this specification the term “geological space” is used to mean real space, i.e. Euclidean space of the appropriate number of dimensions. The term “parameter space” is used to mean a different and unrelated coordinate system where parameter functions can be represented. As described below, parameter space may also be Euclidean space, but need not necessarily be so. Parameter space may have any appropriate number of dimensions according to the particular choice of transformation and form of parameter function. Indeed where several parameters are represented in geological space, they may each be represented in different parameter spaces with different dimensions and different characteristics. This is one of the flexibilities enabled by the separation of structural data from parameter data.

This approach addresses the challenges discussed above. There are two main advantages, firstly to separate the structural model from the property model and allow separate management of each, and secondly to represent the properties in an environment (one or more parameter spaces) where they can be more efficiently managed.

The transformation is preferably performed based on geometrical information only. In particularly preferred embodiments, the geometrical information includes the boundary of the region in geological space and the boundary of the region in parameter space.

To achieve separation and individual management of the structural model (boundary information) and property models (volumetric information), the geometrical transformation is constructed to provide a link between them. There is a connection between the representation of a parameter in its parameter space and the corresponding representation of the parameter in the geological space. This connection, or link, is provided by the transformation, which is preferably a geometrical transformation controlled by the boundary of the domain of the parameter function and the boundary of the corresponding domain (region) in the geological space. The domain of each parameter function is adapted to the type of function used for representing each parameter in its parameter space. The region in the geological space is controlled by the structural model. This link, provided by the transformation, allows (parts of) the structural model alone to be modified while the representation of the properties can be retained. This is achieved by corresponding modifications to the involved transformations. Furthermore, if only the properties change, for example in resolution or in values, the structural model (and hence the transformations) can be retained. Hence both geological structures and properties can be managed more effectively. This results in a more efficient handling of the model as a whole. The described construction is for mathematical convenience; the transformation is used for mathematical encoding and decoding. The parameter spaces and the shape of the regions in which the property models reside have in themselves no geological meaning. As no meaning has to be attributed to these aspects of the model, significant freedom of representation is available. This provides for mathematical and computational simplicity. Geological context is only added when transforming between each parameter space and the geological space by use of the geometrical transformations.

The transformation should preferably allow surfaces in geological space with multiple z-values, so as to enable representation of overturned folds, salt domes and other complex geometries.

Each physical property within each separate sedimentary layer can be individually managed in parameter space in a form potentially based on geological uncertainty, resolution in measurements or derived values, behaviour of the property, redundancy of information and other criteria. Upon evaluation, the property value will be transformed into its correct spatial position in the geological space via the geometrical transformation. Preferably each sedimentary layer (or geological body, namely a mostly continuous volume of sediments deposited under similar conditions and with similar characteristics) represented in the structural model has a separate transformation, and fault models will preferably be used to modify the transformations to account for faulted geometries. If modification to the structural model is undertaken, the transformations will need to be updated accordingly so that properties in their parameter spaces will be transformed to a new spatial location in geological space according to the modified structural model. Updates in the property values are conducted in the parameter space and may take place independently of the structural model, depending on the nature of the modification.

The earth model can be built in any number of dimensions, typically in two, three or four dimensions. Models in two spatial dimensions are simpler to handle, but give a less full picture of the real situation. Models in three spatial dimensions allow full realistic spatial modelling. Both models in two and three spatial dimensions can also include time as a factor. In two spatial dimensions, the region of geological space will be an area. In three spatial dimensions, the region of geological space will be a volume. Representation of time as an extra factor can potentially be accomplished by representing the parameter functions with an additional dimension. In this case the structural evolution may be represented in the structural model, for example as changes in the surfaces over time, and the transformations would require time as an extra parameter.

Regions of geological space may be defined by sets of boundaries. The sets of boundaries that define the regions of geological space may be points, lines, surfaces, etc. From the structural model, a set of regions (closed objects) may be derived which represent the boundaries of the geological objects. Each region is bounded by surfaces (when in three spatial dimensions) of arbitrary complexity and resolution.

When evaluating the structural model to define the geological regions and the transformations, the model will typically be evaluated, at some requested resolution, and surfaces will be sampled at some resolution (for example the full resolution or something coarser). These sampled surfaces are then the basis for constructing the geometrical transformations. The resolution of these transformations is therefore dependent on the sampling of the structural model. Lower resolution means higher computational efficiency. The sampling resolution may vary spatially. For example, one may want higher resolution for inspecting a detail around a well, while the rest of the model can have much coarser resolution as it is not of interest for this particular purpose.

In current tools the model is evaluated at one single resolution, namely the full resolution, both for the structural model and the properties. (Because the evaluation process simply returns the full model.)

The parameter function may take any form, e.g. it may be a scalar, vector, matrix or tensor field. It may be constant in space or it may be spatially varying. It may be smooth or it may have discontinuities. However the function must be defined over the whole region of parameter space which is mapped by the transformation, that is the function must return a parameter value for any coordinate in parameter space that results from the transformation, i.e. that corresponds (under the transformation) to a coordinate in geological space within the relevant region. This is one of the main differences between the invention and grid based approaches. Grid based approaches store data in association with grid cells which are identified by indexes (usually denoted i,j,k). The parameter values stored in the grid are constrained to be at the same static resolution as the grid whereas in the invention, the parameter may be stored in and extracted from the parameter function at any desired resolution.

As described above, storing data in grids controls the resolution at which the data is represented. A large grid cell cannot store and represent fine resolution data. The parameter function on the other hand can represent information as detailed as the data used to generate it. In the simplest form, the parameter function could be a simple constant, i.e. representing that the parameter takes the same value across the whole region. The resolution can also vary, for example if there is detailed information surrounding a well bore as a result of measurements taken during drilling, the parameter function can be generated with high detail (which allows for example capturing of values varying at a high frequency) around the well bore, but can become smoother and more slowly varying (lower frequency components) away from the well bore where data is only interpreted or simulated at a coarser scale due to lower density of measurements and therefore with higher uncertainty. Evaluation of the parameter functions can take place at the resolution requested for the application of the information. Ideally an earth model should store and allow retrieval of information at any spatial location at an optimal quality adapted to the application of the information.

When new data is acquired, new geological interpretations can be provided and new simulations can be performed. Then the parameter functions can be updated to incorporate the new data or to model the region in a different way.

The transformation from geological space to parameter space is an important aspect of this invention. As the idea is not to limit the model to grid points or cells (i.e. the model is preferably gridless), every point in the region of geological space must be mapped to a corresponding point in the region of parameter space. That is, for any given coordinate values within the geological region, the transformation must be able to provide valid corresponding coordinate values within the region in parameter space where the parameter function is defined (i.e. coordinates within the domain of the parameter function), so that a parameter value can be returned. Additionally, to avoid ambiguity, there is preferably only one set of coordinates in parameter space for each distinct set of coordinates in geological space, i.e. the transformation should preferably provide a one-to-one mapping between the region of geological space and the region of parameter space. The transformation is preferably bijective and preferably has an inverse so that any given coordinate in the region of parameter space can be transformed into the corresponding coordinate in the region of geological space. Performing the transformation in this direction (from parameter space to geological space) may have benefits for multi-resolution analysis of properties, e.g. if a real (geological) distance between points is required. It also may provide advantages when sampling points for evaluation, to speed up the sampling process, i.e. the parameter function could be sampled directly in parameter space and the samples transformed to geological space rather than sampling points in geological space and transforming to parameter space to evaluate the parameter function for those points.

The region of parameter space, wherein the domain of the parameter function is specified, can be of any arbitrary shape. However, the shape of a region in parameter space does not need to have any geological significance and can therefore be chosen for mathematical and/or computational simplicity. The choice of the shape of the region in parameter space may depend on the data which are to be represented therein and the choice of function for representing each parameter. For example, the region may be circular or spherical, cylindrical, square, rectangular, triangular or tetrahedral. However, preferably the region of parameter space is a rectangular region. Rectangular here is intended to cover any dimension, e.g. square or oblong in two dimensions, a cube or cuboid in three dimensions, with corresponding extensions to further dimensions. In the most preferred embodiments the region in parameter space is a unit square, cube, etc.

The advantages of using a regular shape, particularly a rectangular one are mathematical convenience. Simplified shapes allow the parameter function to be manipulated (e.g. updated, sampled, transformed, composed, decomposed, approximated) more easily. This is because a simple shape such as e.g. a unit square or cube is then used as the domain for the parameter function. Many functions, for example multi-resolution functions, are simpler to construct and manage over a simple and regular domain such as a unit square or cube, than over for example a domain of polygonal shape as is the case for a typical geological layer. Hence the transformation from a geological body of arbitrary shape to a simple shape, e.g. a square or a cube will also allow types of functions than can only be constructed over a regular domain. This ensures a broader variety of functions to select from, and therefore a better adaptation to the problem at hand. This adaptation can for example be in terms of higher computational efficiency and better control with accuracy.

In some very simple models, there may be only a single geological region, e.g. a single sedimentary layer or a single inter-fault region. However such cases are rare. Therefore preferably the earth model comprises a plurality of regions in geological space. The plurality of regions may identify a number of different sedimentary layers or a number of different inter-fault regions. As described elsewhere, the choice of regions depends on the particular applications and the particular geological configuration under study.

In simple earth models, there may only be a single parameter to model. In such cases, a single parameter function for each region of geological space is sufficient. However, more usually a number of different parameters will be stored and modelled by the same earth model, e.g. porosity, permeability, density, etc. Each parameter is derived from a certain set of measurements and/or interpretations, and has its own characteristics. One such characteristic is the resolution at which it is represented by the parameter function. Therefore each parameter needs a separate parameter function to return an appropriate value for a desired point in geological space. Preferably therefore for each region of geological space a plurality of parameter functions are defined. The domain of each parameter function is a region in parameter space, for example the unit cube. It can also be that a parameter function is mapped onto a super-region corresponding to (and containing parameter values for) several regions in the geological space.

Different parameter functions could also be used to model the raw data or interpretations/simulations of various properties in different ways, e.g. to provide different spatial interpretations of the data across the geological region. The user of the model can simply specify which function is to be used.

The plurality of different parameters may be modelled in parameter space in different ways, depending on the mathematical convenience. For example, one parameter could be represented across a spherical region in parameter space while a second parameter could be represented across a cuboid region in parameter space. In this situation, different transformations would be required for each parameter. One transformation would be required to map the geological region to a sphere while a second transformation would be required to map the geological region to a cuboid. However, preferably the region in parameter space for each of the plurality of parameter functions is the same region. Most preferably it is a unit cube as mentioned above. With this arrangement, the same transformation can be used for all parameters within a particular geological region. It will be appreciated that the use of a single transformation reduces the required storage space for the model as well as simplifying the computation process (e.g. if several parameters are to be looked up, a single set of parameter coordinates can be generated by the transformation and the several parameter functions can be evaluated with the same transformed coordinates).

The choice of region in geological space is also highly variable. Typically, a region in geological space will be chosen to correspond to some region of geological significance, e.g. a whole sedimentary layer or a portion of a layer bounded by faults or a channel (an ancient river bed). The choice of region may depend upon the complexity and the purpose of the model. A channel may have a very complicated structure to interpret and represent (it may be meandering in multiple directions and possibly include branches), but it also may be of especially high interest (e.g. it is likely to have high porosity) and therefore may be worth the added modelling complexity. The geometrical shape of a region, for example a channel, is often the result of a simulation, deterministic or stochastic. This is typical when the lack of available measurements or the quality of the measurements do not support a detailed interpretation of its shape, but a geological interpretation suggests typical shape attributes for the region. The variation of parameters within a sedimentary layer is often relatively low (as all particles were deposited under similar conditions) and therefore defining the region of geological space to be a sedimentary layer (or another type of region with similar characteristics in its interior, often as a result of the sedimentation process that took place) is particularly preferred as it simplifies the parameter functions. Current earth modelling applications often simulate and represent regions, for example channels, by allocating corresponding property values to cells in the grid. The geometries of the channels are thus not explicitly represented in the grid geometry, but appear as variations in property values represented in the grid. The approach of this invention simplifies explicit representations of geological objects with complex geometrical shapes when required, but the more implicit representation of such features via representation in the parameter functions is also supported.

The sedimentary layer or other types of geological bodies will often have been deformed by tectonic processes over time so that it can have a complicated shape. It may also have been split or deformed by faulting. To model the whole layer as one region may therefore require defining the layer in terms of several sub-regions, e.g. one sub-region on either side of a fault. In some preferred embodiments therefore the region of geological space is a discontinuous region comprising a plurality of sub-regions. The added complexity of defining the layer in this way may be offset by the benefit of mapping to a single parameter space with a single parameter function which combines and models data from all of the discontinuous sub-regions which share similar characteristics. The transformation must be defined across all sub-regions. The transformation can advantageously remove the faulting from the parameter modelling by mapping the discontinuous sub-regions of geological space into a continuous region of parameter space where data can more easily be managed. Regions in both the geological space and the parameter space can be split or combined, with corresponding modifications to the transformations.

Coordinates of a region of geological space can be mapped to a region of parameter space by a single transformation or by a series of transformations. Both approaches have advantages. Therefore in some preferred embodiments the transformation mapping the or each region of geological space to a region of parameter space is a single transformation. In other preferred embodiments the transformation comprises a plurality of transformations.

The use of a single transformation may be computationally less demanding and reducing the number of transformations to be stored in the model reduces the size of the model. On the other hand, transformations may be mathematically more straightforward if they are kept separately rather than combined into one. Further, some transformations may correspond to actual geological events, such as a folding transformation or a faulting transformation. These transformations represent geological knowledge which it is useful to store in the model. It also provides greater flexibility if the user can identify a geological event to modify, perhaps to try different geological interpretations. One individual transformation in the series can then be modified without affecting the others, for example to model various geological interpretations. For example, a set of transformations may comprise folding followed by faulting. The fault transformation could be modified by the geological interpreter without having to modify the other transformations and without having to recalculate a single combined transformation.

When modelling the history of tectonic activity, transformations may be defined which cover several sedimentary layers or other geological bodies at once. For example folding and faulting activity will typically affect several different layers in the same activity. Different tectonic activities throughout time will apply to different layers, for example there may be some major folding in one geological era, followed by deposition of several new sedimentary layers before the next major folding in a subsequent geological era. Therefore each transformation in this scenario may apply to (cover) several regions of geological space which, in the current structural model are to be modelled individually. Therefore to build a set of transformations which apply to one current geological region of interest, it may be necessary to generate sub-transformations for sub-regions of the larger transformations. The way in which this is achieved may be varied so long as the end result provides a transformation corresponding to the desired current region of interest in geological space. These transformations may be applied to single points when being transformed from geological space to parametric space to evaluate a parameter value, so that each point is transformed by several transformations. They may also be applied to parts of the geometrical description in the structural model, before this model is used as basis for creating transformations directly from geological space to parameter space.

Furthermore, transformations similar to the ones described may be used to remove the effect of tectonic activities when transforming between geological space and parameter space. The objectives of such transformations are not to accurately represent the geological event, but to transform regions in geological space to parameter space so that they can be managed by a single parameter function. An example is a transformation designed to put two regions in connection when they have been split by a fault, for example to put together the hanging wall side and the footwall side of a layer that has been split by a fault. This amounts to removing the effect of a faulting via the transformation, but without attempting to represent the fault itself in a geologically sound or correct manner. This is useful if the transformation should not include the added complexity of a real geological model. The advantage is that this approach allows managing the parameters of a region (e.g. a sedimentary layer) by a single parameter function, even when the region has been affected by one or more tectonic activities in a manner that is not fully understood. In this case the activities cannot be well represented by geological models. Furthermore, if the geometry of the geological configuration is too complex to comprehend and model by the geologically sound transformations available, one may resort to simpler transformations which do not carry significant geological knowledge but still allow coherent management of parameters.

As described above, the geological regions to be transformed may have complex shapes. They are described by the surfaces in the structural model. Closed regions such as polyhedra (or polygons in 2D) can be extracted (e.g. sampled) from the structural model, and transformations can then be constructed based on these closed shapes. The number of points used to define a region may be varied depending on the necessary level of detail and accuracy. In the case of non-convex shapes (which will frequently be the case, e.g. with overturned folds), the transformation is preferably capable of handling accurately the non-convex mapping.

Some suitable transformations may involve barycentric coordinates or related extensions and developments thereof. Barycentric coordinates were originally used to define a point within a triangle in terms of the masses that would have to be placed at the triangle vertices in order to place the centre of mass at that point. This principle has since been extended to three dimensions, to polygonal and polyhedral shapes, also including non-convex shapes and to shapes bounded by smooth curves. In this specification, the term “generalized barycentric coordinates” will be used to encompass all such extensions of the original concept where points in the interior and sometimes the exterior of the region are defined in terms of points on the region's boundary.

Particularly preferred transformations involve the use of Mean Value Coordinates and developments thereof, due to their particular mathematical simplicity and broad shape-applicability. In preferred embodiments the transformation may be a warp function or morphing function similar to those used in image manipulation or in recent research approaches in the animation industry. Such functions are defined by a boundary of a closed region (or several boundaries of several closed regions) and a boundary of another closed region (or several boundaries of several other closed regions) and provide a mapping between the two regions such that the interior of one region (or regions) is mapped to the other region (or regions). The way in which points are transformed will depend on the particular transformation employed. Also, other transformations utilising only the boundaries of the regions are applicable and will provide various advantages such as computational simplicity (and hence speed).

In preferred embodiments at least one transformation transforms the spatial coordinates in a region in geological space to spatial coordinates in a region of parameter space. Both spaces may be Euclidean spaces and the transformation of coordinates may be via conversion from geological coordinates to generalized barycentric coordinates and thence to parameter space coordinates. In particularly preferred embodiments the generalized barycentric coordinates are Mean Value Coordinates.

In the case of some transformations, including for example Mean Value Coordinates, when mapping a convex region to a non-convex region, or a non-convex region to an even more non-convex region, some points within the convex region may be mapped outside the non-convex region in the vicinity of the non-convexity. It has been found that this problem does not exist when mapping a non-convex region to a convex region. In such cases, all points within the non-convex region are mapped inside the convex region. As described elsewhere, it is not always necessary to perform the transformation from parameter space to geological space. In fact, most of the time transformations are performed only from geological space to parameter space. It is desirable to be able to cope with arbitrary shaped regions of geological space, in particular it is desirable to be able to map non-convex regions of geological space to parameter space. As the boundary of the region of the parameter space has no geological significance, it is preferably chosen to be convex so as to avoid the above mapping irregularities.

There is much scope for different ways to store the raw data and the parameter functions within the model. The function may be stored as one or more mathematical formulae. It may be stored in a compressed format. In some preferred embodiments the parameter function is stored in a decomposed form, e.g. a spatial-frequency decomposition such as a Fourier series or Fourier transform. Fourier based decompositions do not cope particularly well with discontinuous functions and therefore in particularly preferred embodiments the function may be in the form of a wavelet decomposition. Wavelet decompositions often cope better with discontinuities, depending on the type of wavelet function applied. In other embodiments, the function may be represented using multi-level B-spline approximations or binary space partitioning methods like Octree. These forms of representation, and also other multi-scale functions and representations, allow large quantities of point source raw data to be merged together into a single representation which can be evaluated across the whole of the function domain. The resultant decomposed representation can also be compressed very efficiently (either losslessly or in a lossy manner by dropping data which contribute the least value), while allowing control over loss of detail, and can therefore bring about huge benefits in reducing the size of the property representations and therefore the size of the model as a whole, allowing for faster processing and easier transmission over computer networks.

The parameter function, whether composed/decomposed, compressed/non-compressed can be defined and stored in a multi-resolution form. Such representations allow multiscale evaluation. For example, the parameter function can be evaluated on a coarse scale if fine detail is not required or on a fine scale if more detail is required. The scale at which the function is stored/evaluated may vary within the domain. For example, if the density of measurements is higher in a certain portion of the domain, it would justify a more fine-scaled evaluation of the function if the objective is to evaluate according to the associated uncertainty in the parameter values. Furthermore, if the function values vary rapidly in some parts of the domain and less rapidly in other parts of the domain, it may be advantageous to evaluate at a finer scale where the values vary rapidly than elsewhere. A coarse scale evaluation of the function will tend to be less computationally expensive than a fine scale evaluation (for example one could evaluate only the lower frequency components of the function) and therefore allows a trade off between detail and speed to be selected. In preferred embodiments, components of the function are stored and evaluated in a hierarchical fashion with coarser components being stored/evaluated first and finer components being stored/evaluated with lower hierarchical priority.

Therefore in preferred embodiments, at least one parameter function is a multi-resolution function. The at least one parameter function may be arranged in a hierarchical form from coarse resolution to fine resolution. At least one parameter function may be arranged in a compressed form (lossy or lossless). The at least one parameter function may be compressed in a hierarchical form from coarse resolution to fine resolution.

If a function has been decomposed into a number of components, these components can then be arranged into the desired hierarchy (e.g. low frequencies first). The coarsest function components are thus more readily and more quickly accessible. If the function is then compressed, with a progressive algorithm, the decompression algorithm can be stopped once the coarse components have been decompressed, thus avoiding the unnecessary extra computation of a full decompression when it is not required.

According to another aspect, the invention provides a method of building an earth model, comprising the steps of: defining a plurality of regions of geological space; and for each region of geological space: defining at least one parameter function over a region of parameter space; defining at least one transformation which maps coordinates within the region of geological space to coordinates within the region of parameter space; and associating said at least one transformation and said at least one parameter function with said region of geological space;

The preferred features described above in relation to the earth model itself apply equally to the method of building an earth model.

A further aspect of the invention provides a method of updating an earth model as described above, comprising updating at least one transformation while retaining the association with the corresponding geological region and parameter functions.

Another aspect of the invention provides a method of updating an earth model as described above, comprising updating at least one geological region and at least one associated transformation while retaining the association with the corresponding parameter functions.

Yet another aspect of the invention provides a method of updating an earth model as described above, comprising updating at least one parameter function while retaining the association with the corresponding transformation and corresponding geological region.

It will be appreciated that the above model updating methods can of course be combined together if desired.

According to a further aspect, the invention provides a method of generating a representation of at least one parameter using an earth model as described above, comprising the steps of: selecting a plurality of points in geological space where the parameter is to be represented; and for each selected point, identifying the region of geological space containing said point; transforming the geological space coordinates of said point into parameter space coordinates using the transformation associated with the geological region; evaluating the parameter function associated with the geological region to produce a parameter value for said point, and representing the value of said point at a spatial location representing said point.

In preferred embodiments, the step of evaluating the parameter function includes evaluating the parameter function at a variable resolution. The parameter function may be evaluated at a spatially varying resolution, e.g. it may be evaluated at high resolution in a region of particular interest while being evaluated at a lower resolution at regions of less interest. The varying resolution may depend on the uncertainty in the parameter data with higher resolution being associated with lower uncertainty.

According to a further aspect, the invention provides a software product comprising instructions which when executed by a computer cause the computer to define a plurality of regions of geological space; and for each region of geological space: define at least one parameter function over a region of parameter space; define at least one transformation which maps coordinates within the region of geological space to coordinates within the region of parameter space; and associate said at least one transformation and said at least one parameter function with said region of geological space. The software product may be a physical data carrier. The software product may comprise signals transmitted from a remote location.

According to a further aspect, the invention provides a method of manufacturing a software product which is in the form of a physical data carrier, comprising storing on the data carrier instructions which when executed by a computer cause the computer to define a plurality of regions of geological space; and for each region of geological space: define at least one parameter function over a region of parameter space; define at least one transformation which maps coordinates within the region of geological space to coordinates within the region of parameter space; and associate said at least one transformation and said at least one parameter function with said region of geological space.

According to a further aspect, the invention provides a method of providing a software product to a remote location by means of transmitting data to a computer at that remote location, the data comprising instructions which when executed by the computer cause the computer to define a plurality of regions of geological space; and for each region of geological space: define at least one parameter function over a region of parameter space; define at least one transformation which maps coordinates within the region of geological space to coordinates within the region of parameter space; and associate said at least one transformation and said at least one parameter function with said region of geological space.

The tools for building, updating, storing and accessing the earth model will typically be embodied in computer software and/or hardware. Components of the model, e.g. the structural model, the parameter functions, the boundaries defining the geological regions and the transformations may be stored in databases, data structures or data objects on physical data carriers or loaded into volatile memory for use. The model may be stored centrally for simultaneous access by several users and it may be shared over computer networks. The apparatus and methods described herein may be implemented in computer hardware and/or software.

Preferred embodiments of the invention will now be described, by way of example only, and with reference to the accompanying drawings in which:

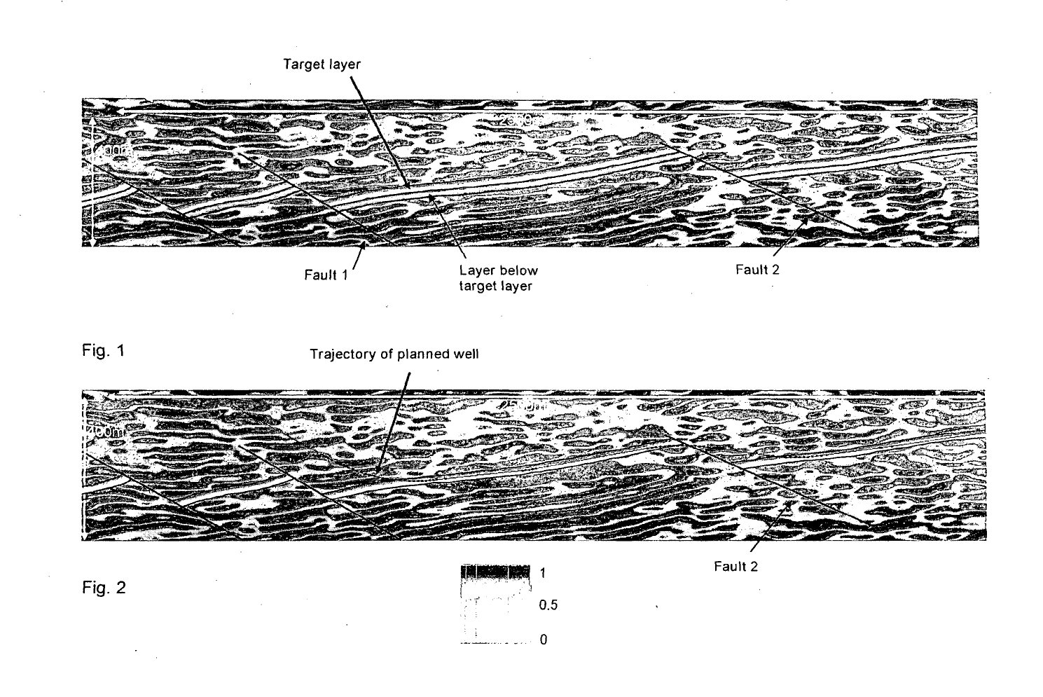

FIG. 1 shows a seismic section along a well fence of a planned well trajectory. Two depositional layers are depicted;

FIG. 2 shows the same well fence as FIG. 1 but only the target layer is shown. A planned well trajectory for a horizontal well is also shown;

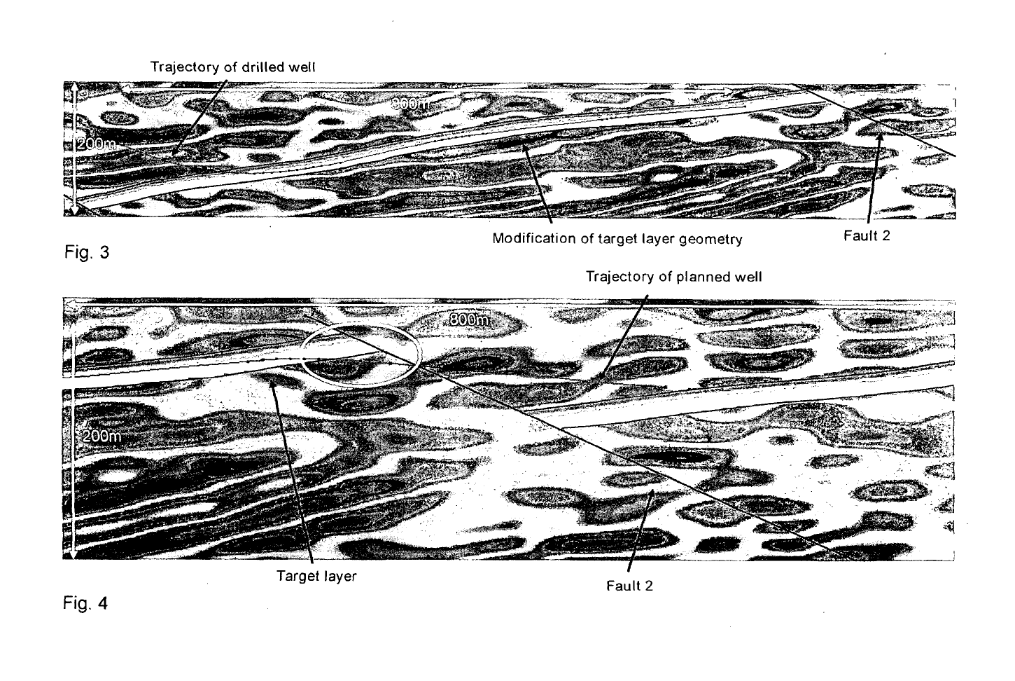

FIG. 3 shows a modification of the target layer geometry and well trajectory after the target layer was displaced upwards by about 20 metres compared with the view shown in FIG. 2;

FIG. 4 shows a close up view of Fault 2 and the target layer before modification of the fault geometry;

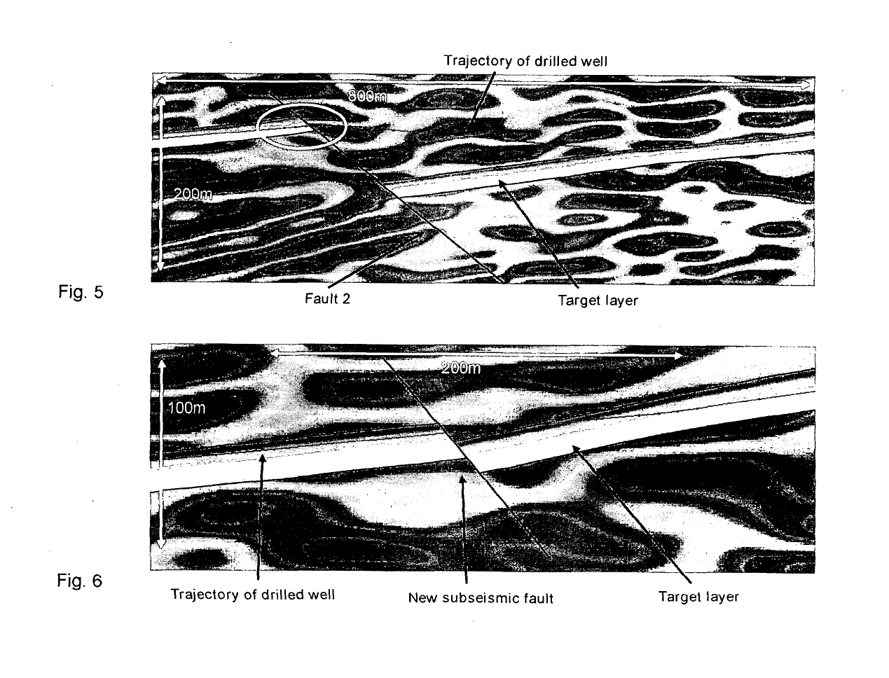

FIG. 5 shows a view similar to that of FIG. 4 but modified to show an updated geometry;

FIG. 6 illustrates insertion of a subseismic fault to the right of Fault 2;

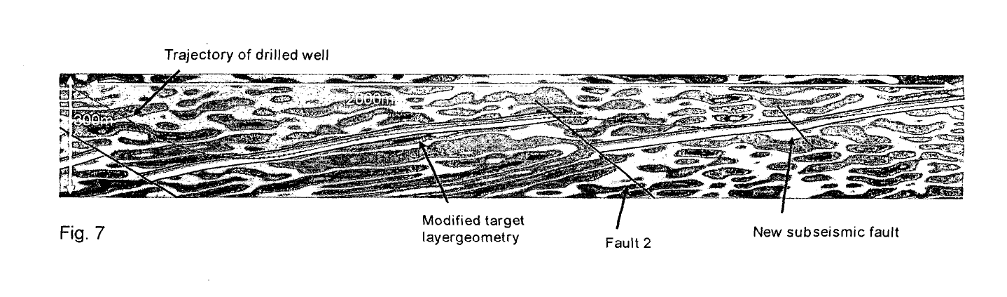

FIG. 7 shows the updated earth model corresponding to the view of FIG. 2, but including the modifications illustrated in FIGS. 3, 5 and 6;

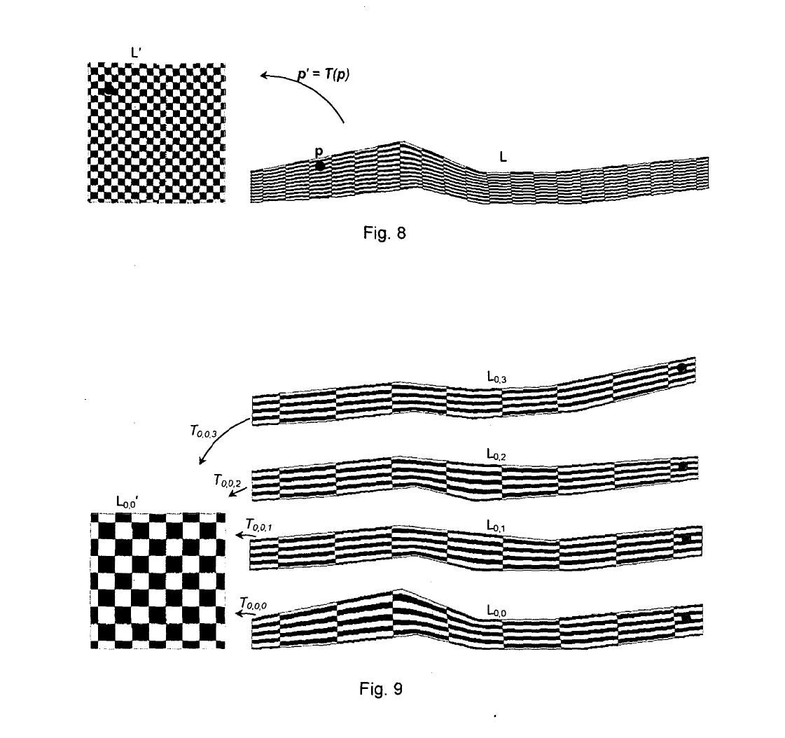

FIG. 8 illustrates a geometrical transformation transforming coordinates from a geological region to a parameter region;

FIG. 9 illustrates a number of different geological interpretations all mapping to a single parameter region;

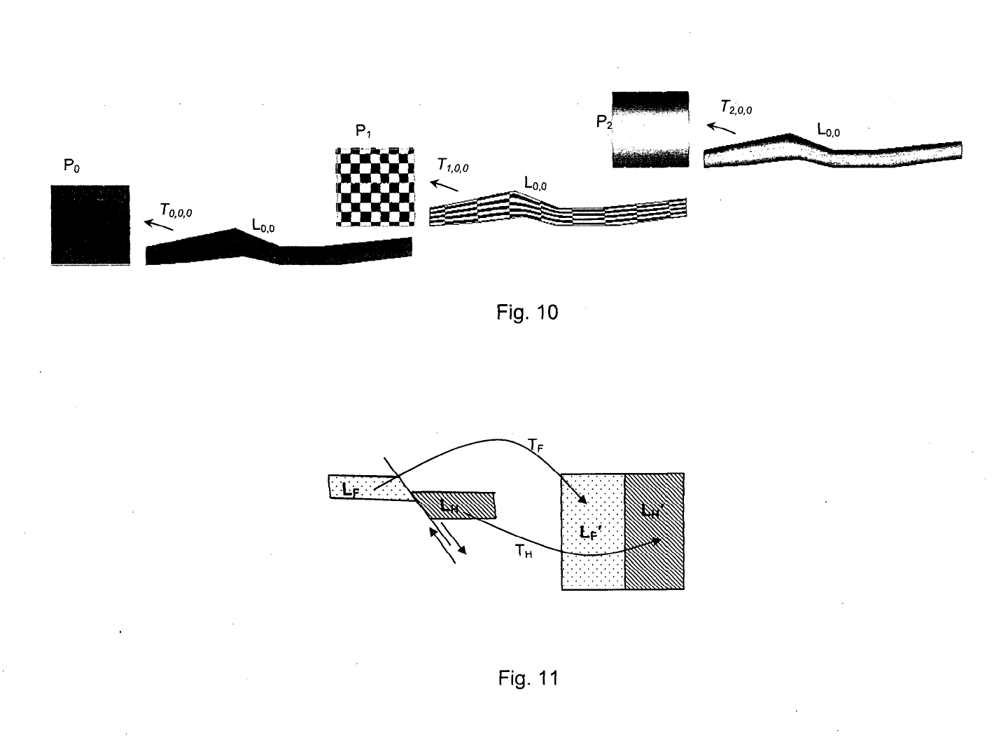

FIG. 10 illustrates a single geological region with three separate properties each being represented in its own separate parameter region;

FIG. 11 illustrates fault management where two transformations are used to map to a single parameter region;

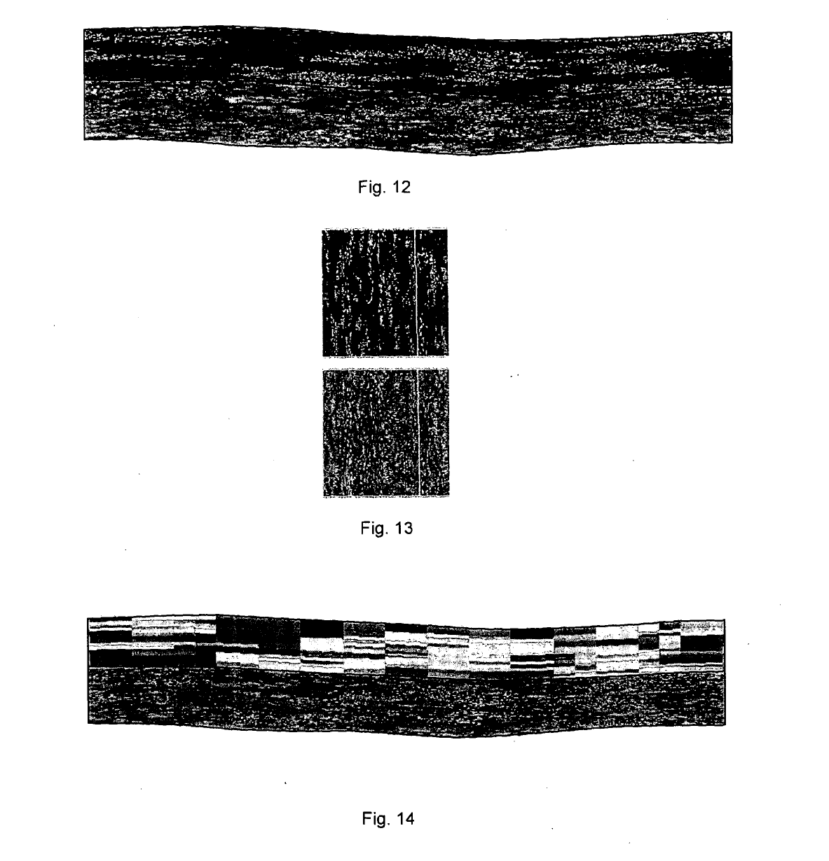

FIGS. 12 and 14 illustrates evaluation of properties at two different resolutions. The property functions are shown in FIG. 13;

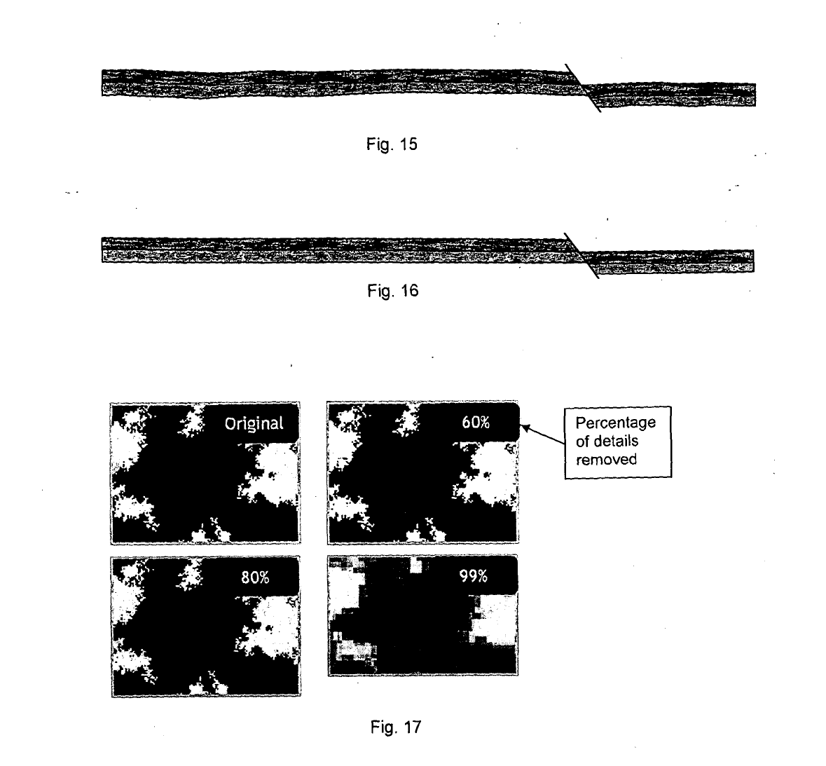

FIG. 15 depicts a faulted model where the geological structure is evaluated at a fine resolution. The properties are the ones depicted in FIG. 13;

FIG. 16 shows the same faulted model as in FIG. 15, but the structural geometry is evaluated at a coarser resolution;

FIG. 17 illustrates a multi-resolution property function evaluated at various scales;

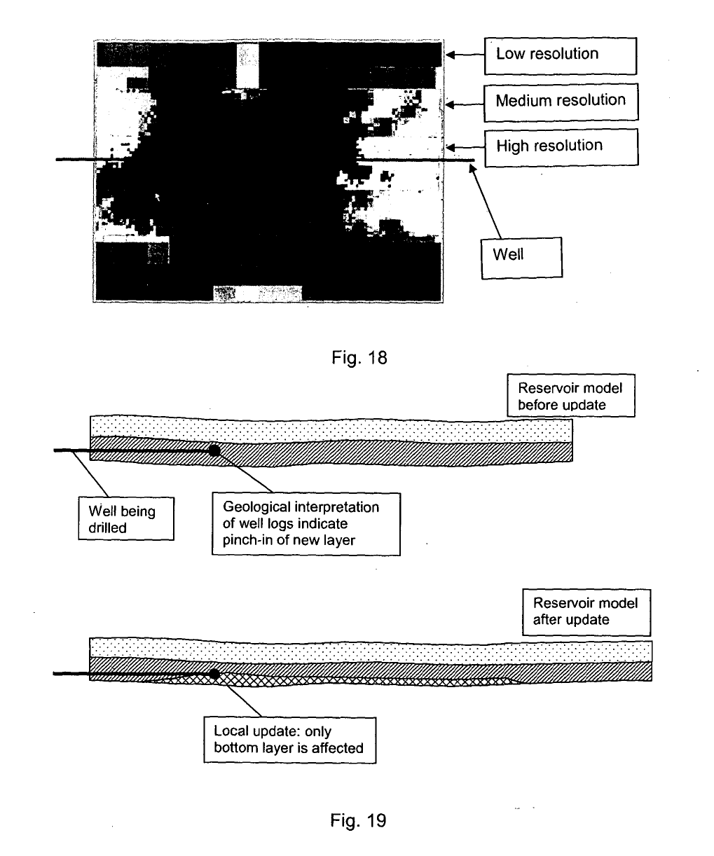

FIG. 18 illustrates how the property function in FIG. 17 can be evaluated at various resolutions around a well which defines the region of interest. Near the well the resolution is high, further away from the well the resolution is coarser. The geological structure and therefore the transformations would remain the same;

FIG. 19 illustrates a local model update where a previously unknown sedimentary layer is inserted during drilling;

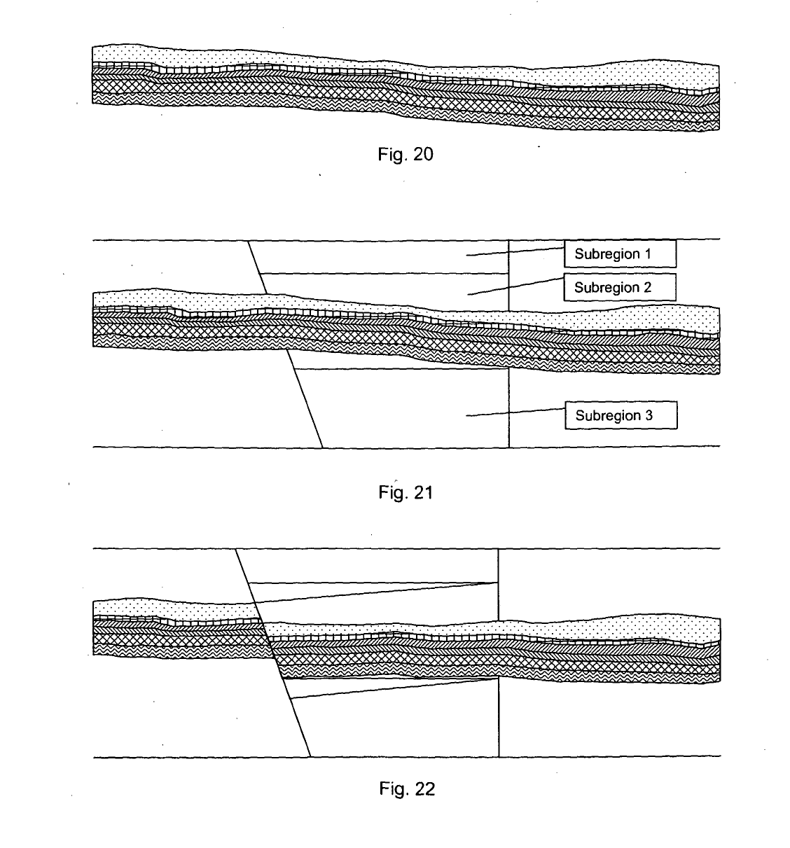

FIGS. 20-22 exemplify how a geometrical transformation utilised in a fault model can be applied for insertion of a small fault in a geological model; and

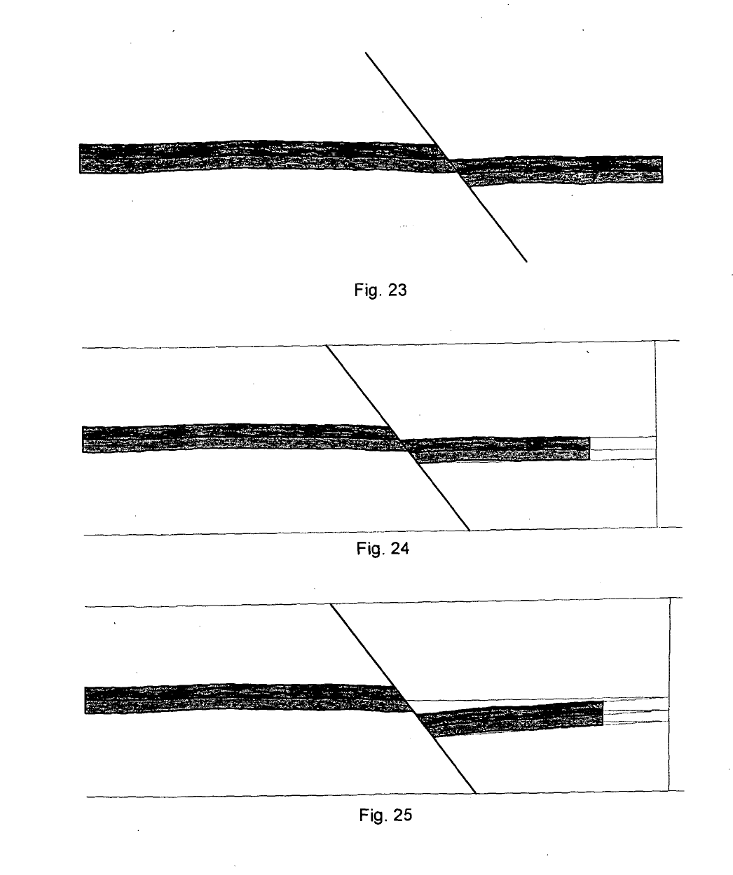

FIGS. 23-26 show how a geometrical transformation utilised in a fault model can be applied for update or removal of an already existing fault in a geological model.

The basic methodology of the invention will first be described with reference to FIGS. 8 to 11. A number of examples of the application of the invention will then be described with reference to FIGS. 1 to 7.

Looking at FIG. 8, the geometrical transformation T is used when deforming a source body L into a target body L′ by geometrically modifying its boundary into another shape. The interior of L is represented in terms of its boundary via T, and when this boundary is deformed the interior implicitly follows the deformation in a continuous and intuitive fashion. This procedure is also known as volume deformation.

Any point p in L can be transformed into a corresponding point p′ in L′ by applying the transformation T:

p′=T(p) (1)

In FIG. 8 we see how the deformed checkerboard pattern in L is obtained by first defining colours in L′ as in a checkerboard. We have then transformed each point p in L to its corresponding point p′ in L′, allocated a colour (black or white) to p′ according to the checkerboard pattern in L′, and finally drawn p in L with the colour allocated to p′. Hence the regular pattern in L′ depicts the deformation of the interior of L when transforming from L to L′.

It can be seen that this process only involves application of the transformation in one direction, i.e. transforming p to p′. The inverse transformation is not required in this process. It is necessary for all points in L to map to a point in L′, but it is not necessary for all points in L′ to map under an inverse transformation to points in L. It will however be appreciated that the inverse transform may be useful in some situations and it is therefore preferred that the transformation be bijective. One situation in which the inverse transform may be useful is in the mapping of non-scalar fields or modelling of parameters which depend on distance or direction information. Distances and directions will be distorted under the transformation and so to evaluate such information may require transformation in the reverse direction, from a point in parameter space to a point in geological space for example to extract the correct spatial distance between two points.

Now, let us apply the concept in a geological setting. In our examples the body L in S_{GEO}, the geological space, represents a sedimentary layer, although in other embodiments it could equally well represent other types of geological bodies such as inter-fault regions or channels. The interior of L contains physical properties like petrophysical and formation properties. But instead of being represented in terms of a grid over the interior of L as in standard earth modelling techniques, the properties are represented in L′ which resides in what we denote S_{PAR}, the parameter space. By application of T, the properties can be evaluated in L′ before their values are carried over to L, analogue to the example in FIG. 8. The most important thing to notice is the separation of structural geometry (the boundary of L) and physical properties in the interior of L by application of T, so that properties are represented in L′ rather than in L. L′ can be chosen to have a geometric shape which allows a simpler and more useful parameterization than L. This may allow property information to be more efficiently managed, for example by various well-known multi-resolution algorithms.

To simplify further explanation, we will continue with a few definitions. As we have seen, the geometrical transformation T can transform any point p in L to p′ in L′, and it depends only on the geometries of the boundaries of L and L′.

Let P be a physical property. It is represented in the interior of L′ in S_{PAR}, and to manage it we use a function G. Hence L′ represents the domain of G. G can be evaluated at any point p′ in L′: g=G(p′). The requirements for G and how it is represented can vary. To enable management of the property in S_{GEO} we establish the function F. The property can be evaluated at any point p in L: f=F(p), so that f is the value of the property at p. For comparison, note that in grid-based earth modelling approaches, evaluation of F may amount to searching through a grid to find the grid cell containing p and returning the value f of the property in that grid cell.

By application of Eq. (1), the following relationship between F and G is now established:

f=F(p)=G(T(p))=G(p′)=g (2)

It can be used so that whenever we want to evaluate a property value F(p) for a point p in L, for example for visualization or simulation purposes, we just apply the transformation, p′=T(p), before we evaluate G(p′).

For each sedimentary layer there are many properties P, we index them by m so that Pₘ denotes a certain property. Furthermore, in a geological model there are many layers and other geological bodies. Each layer is allocated an index n. And, as we are concerned with updates of the structural model, each interpretation of the geometry of a layer has an index i so that each layer L_{n,i} in the model is indexed both by n and i.

Because F and G are dependent on property type and geometrical information, we obtain that f=f_{m,n,i}=F_{m,n,i}(p) denotes the value of property m in layer n with a current interpretation i of its geometry at the point p. Likewise, g==G_{m,n,i}=G_{m,n,i}(p′) is the same property value in the parameter space, and they are linked as established in Eq. (2). The transformations in general depend on the geometries of their target bodies and the parameter space and of the property we address, thus they can be represented as T_{m,n,i}(p).

### Structural Modifications

Now we consider how we can retain the property model even when the structural model is modified. The key is that for all versions i of the layer geometry of a given layer n, we apply the same target body L_{m,n}′ in the parameter space. L_{m,n}′ in general depends on the property Pₘ and which layer n we address, but not on the current interpretation i of the layer geometry. L_{m,m}′ is from now on denoted the reference body for some property m and layer n. Hence each transformation T_{m,n,i} will be a transformation from L_{n,i} to the reference body L_{m,n}′. As the reference body is kept constant for all interpretations i of the layer L_{n,i}, G will not depend on i and will be indexed by G_{m,n}.

In practice the boundary of the reference body may also be independent of the property m and which layer n we address. Then we would use the boundary of the same reference body L′ for all properties and layers, namely so that L_{m,n}′=L′ for all m and n, but this is not a requirement. The reference bodies should be adapted to their application.

In FIG. 9 there are four different interpretations L_{n,i}, i=0, . . . , 3, of the geometry of a layer, n=0. This is the result of a modification of the interpretation of the layer geometry. For example, this may occur during drilling of a new well when we receive more information, if we wish to consider several alternative geometrical interpretations of the same layer in an earth model, or if we have several realizations from a stochastic modelling of the layer geometry.

We underline that it is a requirement for T that upon modification, the two points p₀ in L_{n,0} and p₁ in L_{n,1}, where L_{n,0} and L_{n,1} are two different interpretations of the geometry of the same layer, should transform to the same point p′ in L′:

T_{m,n,0}(p₀)=T_{m,n,1}(p₁)=p′ (3)

Each point p₀ and p₁ represents the same point from a geological perspective in the sense that they have equal locations with respect to the layer in which they are embedded. See the dots to the right in FIG. 9 for an example. When combining Eq. (1), Eq. (2) and Eq. (3), we see that when we evaluate a certain property Pₘ in p₀ and p₁, the value will be the same:

f=F_{m,n,0}(p₀)γG_{m,n}(T_{m,n,0}(p₀))=G_{m,n}(p′)γG_{m,n}(T_{m,n,1}(p₁))=F_{m,n,1}(p₁) (4)

We have seen that we can transform points inside a geological body to a reference body by applying the geometrical transformation T given in terms of the boundaries of the two bodies. This way we have connected the reference body, whose shape never changes, to a sedimentary layer which can take many shapes. This methodology can be applied to all layers, and potentially any type of geological body in an earth model.

In FIG. 9, the geometry of layer n=0 in the earth model is the subject of modification, and the property addressed is P₀. The layer L_{0,0} is first modified into L_{0,1}, then into L_{0,2}, and finally to L_{0,3}. Correspondingly, we generate the transformations T_{0,0,0}, T_{0,0,1}, T_{0,0,2} and T_{0,0,3}. They transform between each L_{0,i} and the reference body L_{0,0}′, respectively. The reference body L_{0,0}′ is not changed. The same procedure for colouring the interior of each L_{0,i} as in FIG. 8 is applied. The dots to the right in each layer L_{0,i} denote points that are equal from a geological perspective.

### Individual Management of Each Physical Property

Each property Pₘ can be separately managed for each layer in the earth model via F_{m,n,i}. This allows that each F_{m,n,i} can be represented and evaluated individually. For example, its representation can potentially have a resolution adapted to the uncertainty of Pₘ, and the resolution when evaluating F_{m,n,i} can be adapted to the application of the information. The information can be applied e.g. for visualization or simulation purposes.

In FIG. 10 we have exemplified separate management of three synthetic properties Pₘ, m=0, . . . 2, within a layer represented by three separate functions G_{m,0} in S_{PAR}. Here P₀ is constant within the whole layer, P₂ varies only in the vertical direction, whereas P₁ is more complex. When more information becomes available, for example during drilling, each of the three property representations could be modified to another form better suited for representing the new information. Notice that in practice we could choose a more effective representation of P₀, and let G_{0,0} return a constant value without applying T. Along the same lines, G_{2,0} could evaluate values from a function depending only on location in vertical direction with respect to the formation top and bottom, and not on horizontal location.

### Management of Faults

Initial fault management is basic and aimed at indicating how faults may be handled. The hanging wall side L_{H} and the footwall side L_{F} of a layer, where L_{H} and L_{F} together constitute a layer L, generate two separate transformations T_{H} and T_{F} as depicted in FIG. 11. The target shapes of the two transformations are L_{H}′ and L_{F}′, respectively, generated by splitting L′ along a (near) vertical line (the choice of line position and angle can be selected for accurate representation of the fault geometry in the parameter function). If the fault or horizon geometries are modified, L_{H} and L_{F} are modified correspondingly and two new transformations are generated. L_{H}′ and L_{F}′ remain the same.

This approach implies that the effect of faulting is removed from the property representation in the parameter space, therefore each property within the layer is managed independently of fault compartments if required. Furthermore, management of faults in the model is very simple, and only requires manipulation of the geometrical transformations involved.

### The Geometrical Transformation

Barycentric coordinates can be used to express a point inside a triangle as a convex combination of their vertices. These coordinates have recently been generalised to polygons (2D) and polyhedra (3D) of more general forms (including non-convex shapes and volumes).

The geometrical transformation used in the examples below exploits the so-called Mean Value Coordinates (see Floater, M. S. 2003 “Mean Value Coordinates”, Computer Aided Geometric Design, 20(1), pp. 19-27) as a way of expressing a point in the kernel of a star-shaped polygon as a convex combination of its vertices. There are many further developments of this method, including how to generalize the coordinates to polyhedra (3D), use of the coordinates for closed triangular meshes in 3D, and extension to more arbitrary polygons.

Due to the simplicity of the Mean Value Coordinates and the fact that they can be highly efficiently evaluated on a computer, they represent a particularly attractive choice of method for the geometrical transformation.

### EXAMPLES

An embodiment of the invention is described here in two dimensions. The use of two dimensions is for demonstrating the basic principles of the invention and as described above, it can be seen that these principles extend readily to three dimensions, or indeed to more than three dimensions.

The model input is structural geometry in depth along a well fence (i.e. along a plane which intersects a planned well trajectory). The scenario imitates potential structural modifications that can be made during a real drilling event, namely the update of horizon geometry, of fault geometry and the insertion of a subseismic fault. The seismic in depth is used as a reference for the geometrical modifications. It is therefore kept constant, although in a real scenario it may have been more correct to modify the time/depth conversion which would also modify the seismic.

The property shown within the layers is a synthetic property (i.e. not meant to be a physically realistic one) with a gradient in the vertical direction. It is placed according to the layer geometries by using the geometrical transformations. The property could represent any property which can be described by a scalar, e.g. porosity.

In the following it will be seen that modifications of geological structures can take place without compromising the existing property representation.

FIG. 1 depicts a modelled reservoir at around 2000 m depth, with two depositional layers shown, one immediately above the other. The top layer is the target layer (pay zone). The reservoir contains some major normal faults. FIG. 2 shows the initial interpretation of the 20 m thick target layer geometry. The thin black line through the layer describes the trajectory of the planned well. The planned trajectory enters from the left and follows the target layer by drilling through Fault 2. The inset in FIG. 2 shows the representation of a parameter of the target layer in parameter space, varying from 0 at the bottom of the layer to 1 at the top of the layer.

During drilling, directly after penetration of the formation top, the interpretation of the layer geometry as shown in FIG. 2 proved to be reliable. However, later during drilling it was established that the layer was dipping more upwards than first anticipated. The layer geometry was modified accordingly with a maximum vertical displacement of 20 m in an upwards direction (mostly in the middle of the figure), and the well trajectory was updated to follow the modified geometry. The modified model is depicted in FIG. 3. To effect this change in the model, the structural model was updated (i.e. the boundary of the target layer was changed to a new shape matching the layer shape indicated from the well data) and the transformation from the geological domain to the parameter function was updated to transform the parameter data to the new shape. The parameter data required no updating in this process.

Prior to penetrating the large fault shown to the right in the Figures (labelled Fault 2), it was expected to drill through the bottom of the target formation and shortly enter the layer below as shown in the circled area of FIG. 4. However, the real-time logs indicated that the fault was penetrated first (see circled area in FIG. 5), and thereafter a formation above the target formation was entered. The interpretation of the fault location and dip was modified according to this new information as shown in FIG. 5. The planned well trajectory was not updated, and the pay zone was entered according to plan. To effect this change, a similar procedure to that described above was followed. The update of the fault model changed the shape of the target layer to the left and to the right of the fault. These updates to the structural model necessitated corresponding changes to the layer transformation which maps geological space to parameter space. The updated transformation simply altered the mapping between the parameter space and the geological space. The parameter data (i.e. the parameter function) did not require any modification.

In the last part of the well being drilled, a small fault not recognised from seismic was encountered. It was inserted into the model with a throw of 10 m as seen in FIG. 6. Shortly after, the target formation was entered again. This confirmed the geological interpretation, and there was no need for modifying the well trajectory. Once again, the change here is an update to the structural model by splitting one region of the target layer into two sub-regions of the target layer, one on each side of the new fault. The geometrical transformation was updated to map these two new regions to the region of parameter space previously representing the single layer region. Therefore no update to the parameter data was required.

In FIG. 7 the final earth model after modifications is shown, i.e. including the modified layer geometry with the modified well trajectory, the modified representation of Fault 2 and the newly inserted subseismic fault.

FIGS. 12, 13 and 14 illustrate evaluation of properties at two different resolutions. The model in FIG. 12 contains two regions (a top region and a bottom region), and the petrophysical property is evaluated at full resolution in both its top and bottom region. The two property functions used in FIG. 12 and FIG. 14 are depicted in FIG. 13. In FIG. 14 the same model as in FIG. 12 is shown, but the property associated with the top region is evaluated at a coarser resolution. In both cases (FIGS. 12 and 14), the geological structure and hence the associated geometrical transformations remain the same. Using a less detailed evaluation in the property representation results in fewer computations for model evaluation, so that the model can be evaluated in a shorter time. Note that only the leftmost part of the model is shown in FIG. 12 and FIG. 14, so that only the leftmost part of the properties in FIG. 13 are included. Also note that the geological layers in FIGS. 12 and 14 are stretched significantly in the horizontal direction with respect to the property representations in FIG. 13.

FIG. 15 depicts a faulted model where the geometry of the geological structure is evaluated at a fine resolution. The properties are the ones depicted in FIG. 13. FIG. 16 shows the same faulted model as in FIG. 15, but the geometry of the structural geometry is evaluated at a coarser resolution. In this evaluation, geometrical detail is assumed to be insignificant, but the overall shape is retained. For this particular example the layers appear as flatter than in FIG. 15 as the roughnesses are removed. As the transformations depend on the geological structure they are not the same as for the model in FIG. 15, but the property functions are identical. Less geometrical detail results in fewer computations for model evaluation, so that model evaluation is more effective.

FIG. 17 shows a multi-resolution property function evaluated at various scales, i.e. at full resolution and with 60%, 80% and 99% of the details removed. Evaluating the function at lower resolution (i.e. with less detail) requires far fewer calculations. FIG. 18 illustrates how the property function in FIG. 17 can be evaluated at various resolutions around a well which defines the region of interest. Near the well the resolution is high (with lots of detail retained). Further away from the well the resolution is coarser (with less detail evaluated). This technique allows a faster representation of the model (fewer calculations required), while retaining a high level of detail where it is most needed (adjacent the well). The geological structure and therefore the transformations would remain the same.

FIG. 19 illustrates an example of a local model update during drilling. The model at the top shows a geological interpretation of the available information prior to drilling. During the drilling operation, a geological interpretation of the measurements received while drilling indicates pinch-in of a previously unknown sedimentary layer from underneath. The model can be modified with this information by subdividing the original bottom layer into two layers according to the new interpretation, and a suitable representation of their properties. The already existing property representations for this layer could possibly be re-used in the updated model. This is a local model update as only the geometry and associated transformation of the bottom layer of the initial model is affected, the rest of the model remains as it was.

FIGS. 20-22 exemplify how geometrical transformations can be applied for insertion of a small fault in a geological model. FIG. 20 shows an initially unfaulted model with six sedimentary layers. In FIG. 21 the volume of interest is shown, namely a main region which covers a part of the geological model. The main region is subdivided in three different subregions by the two horizontal control lines. Subregion 1 is at the top. Subregion 2 is in the middle containing the six sedimentary layers. Subregion 3 is at the bottom. For each subregion a geometrical transformation is constructed from the boundary given by the appropriate parts of the boundaries of the main region, and the appropriate control lines. The result is a basic fault model which can be geometrically altered in a very effective manner. Now the control lines can be manipulated as indicated in FIG. 22. The control lines are manipulated by a fault model containing information about the displacement of the fault. The horizontal control lines indicate the initial location of the control lines, whereas the angled control lines show their geometry after manipulation. The transformations set up for each of the three modified subregions are used to manipulate their interiors. The geometrical effect is that points in the interior of the subregions are manipulated by the transformations constructed as described above. These points can be points where property values have been evaluated, or they can be points in the geological structure (e.g. horizons). In this example the effect of the faulting is largest to the left hand side where the displacement is largest, and dies out towards the right when compared to the initial model. Outside the volume of interest the model is not modified. The top region (subregion 1) is stretched vertically at its left hand side, whereas the bottom region (subregion 3) is compressed vertically at its left hand side. For this example this is of no interest because these regions do not intersect with the geological model. Inside subregion 2 the layers have retained their thicknesses after the model update. In other embodiments, the geological model (i.e. the subregion of interest) could be stretched or compressed by the faulting.

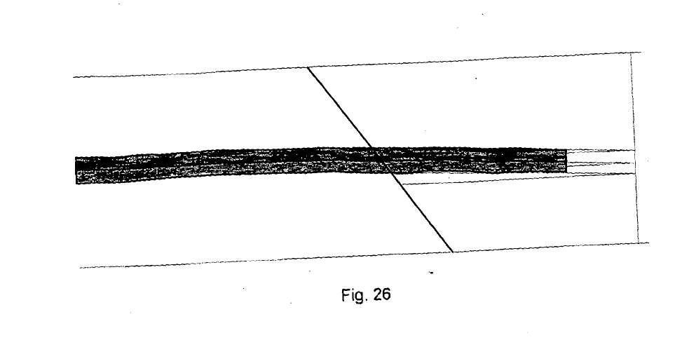

FIGS. 23-26 show how geometrical transformations applied in a fault modification model can be used for update or removal of an already existing fault in a geological model by using the construction described for FIGS. 20-22 above. FIG. 23 displays the initial faulted model. In FIG. 24 we see the volume of interest, analogous with FIG. 21 (the volume to the right of the diagonal line in FIG. 24). In FIG. 25 the fault displacement is increased compared to the initial model in FIG. 23. In FIG. 26 the fault displacement is set to zero. By combining fault removal and fault insertion, it is possible to translate a fault in a geological model by modifying its location. First the fault is removed and then it is re-inserted at a slightly different location, while otherwise retaining the properties of the fault.

The approach described for FIGS. 20-26 is an example of using a series of transformations for mapping a point first from the geological space to parameter space, then to an updated location in geological space corresponding to a model update. First assume we have the faulted model described in FIG. 23. One way of updating the model where the fault displacement is increased as in FIG. 25, is by first evaluating the model as in FIG. 23. To accomplish this we use the transformations corresponding to this geological structure for mapping each point where the property is to be evaluated, from geological space to the parameter space. Now, to achieve the increased fault displacement we map each of the points once more using the transformations constructed from the fault modification model as shown in FIG. 25. This procedure is an example of a local model update where only the model inside the region of interest, namely the region covered by the fault modification model, is updated. The transformations are applied separately and independently in a series to construct different geological configurations, first to evaluate property values and then to modify the geological structure. The main geological information carried by the fault modification model is the displacement of the fault. We have exemplified that using this piece of geological knowledge in combination with a simple geometrical fault model, it is possible to manipulate the geological model in a highly automated fashion. Fault displacement is often vital information which is useful to store in the model directly. By manipulating the fault displacement, different geological configurations can be swiftly generated.

The above approach is a gridless mathematical framework for earth modelling. This lack of reliance on grids is a fundamental feature of the approach and it addresses several limitations of current grid-based earth modelling methodologies. As has been demonstrated, basic modifications of geological structures can be made without compromising the existing property information. The lack of a grid means that such modifications do not result in the need for regridding or the consequential rerunning of simulations in order to provide valid property data for the new structure. Formation and petrophysical properties are kept separately, yet linked with the structural model via the geometrical transformation. When structural modifications are conducted, the existing property information can automatically be placed in correspondence with the new boundary information.

The examples described above are in two dimensions for simplicity, but the geometrical transformation applied in the examples above has known extension to three dimensions. This approach is therefore valid for full three dimensional earth modelling and model updates. The ability to alter parameter data and structural data independently avoids the need to rerun workflows and allows new data to be incorporated into the model in real time, i.e. fast enough for the revised (and up to date) model to be used for making decisions about the current drilling strategy, such as real time changes of drill direction in geosteering processes. Furthermore, effective management of properties can be achieved by applying multi-scale methods.

1. An earth model comprising:
a plurality of regions in geological space;
associated with each said region in geological space, at least one parameter function defined over a region in parameter space;
associated with each region in geological space, at least one transformation which maps coordinates within the region of geological space to coordinates within the region of parameter space.

2. An earth model as claimed in claim 1, wherein the region of parameter space is a rectangular region.

3. An earth model as claimed in claim 1, wherein for each region of geological space a plurality of parameter functions are defined over regions of parameter space.

4. An earth model as claimed in claim 3, wherein the region in parameter space for each of the plurality of parameter functions is the same region in parameter space.

5. An earth model as claimed in claim 1, wherein the region of geological space is a discontinuous region comprising a plurality of sub-regions.

6. An earth model as claimed in claim 1, wherein the transformation mapping the or each region of geological space to a region of parameter space is a single transformation.

7. An earth model as claimed in claim 1, wherein the transformation mapping the or each region of geological space to a region of parameter space is a plurality of transformations.

8. An earth model as claimed in claim 1, wherein the at least one transformation transforms the spatial coordinates of geological space to spatial coordinates of a parameter space.

9. An earth model as claimed in claim 8, wherein the transformation involves conversion from geological coordinates to generalized barycentric coordinates and then from the generalized barycentric coordinates to parameter space coordinates.

10. An earth model as claimed in claim 1, wherein the or each region of parameter space is a convex region.

11. An earth model as claimed in claim 1, wherein at least one parameter function is a multi-resolution function.

12. An earth model as claimed in claim 11, wherein the at least one parameter function is arranged in a hierarchical form from coarse resolution to fine resolution.

13. An earth model as claimed in claim 1, wherein at least one parameter function is stored in a decomposed form, preferably in the form of a wavelet decomposition.

14. An earth model as claimed in claim 1, wherein at least one parameter function is arranged in a compressed form.

15. An earth model as claimed in claim 14, wherein the at least one parameter function is compressed in a hierarchical form from coarse resolution to fine resolution.

16. An earth model as claimed in claim 1, wherein the or each transformation has an inverse transformation which maps coordinates within the region of parameter space to coordinates within the associated geological region.

17. A method of building an earth model, comprising the steps of:
defining a plurality of regions of geological space; and for each region of geological space:
defining at least one parameter function over a region of parameter space;
defining at least one transformation which maps coordinates within the region of geological space to coordinates within the region of parameter space; and
associating said at least one transformation and said at least one parameter function with said region of geological space;

18. A method as claimed in claim 17, wherein the region of parameter space is a rectangular region.

19. A method as claimed in claim 17, comprising for each region of geological space, defining a plurality of parameter functions over regions of parameter space.

20. A method as claimed in claim 19, wherein the region in parameter space for each of the plurality of parameter functions is the same region in parameter space.

21. A method as claimed in claim 17, wherein the region of geological space is a discontinuous region comprising a plurality of sub-regions.

22. A method as claimed in claim 17, wherein the transformation mapping the or each region of geological space to a region of parameter space is a single transformation.

23. A method as claimed in claim 17, wherein the transformation mapping the or each region of geological space to a region of parameter space is a plurality of transformations.

24. A method as claimed in claim 17, wherein the at least one transformation transforms the spatial coordinates of geological space to spatial coordinates of a parameter space.

25. A method as claimed in claim 24, wherein the transformation involves conversion from geological coordinates to generalized barycentric coordinates and then from the generalized barycentric coordinates to parameter space coordinates.

26. A method as claimed in claim 17, wherein the or each region of parameter space is a convex region.

27. A method as claimed in claim 17, wherein at least one parameter function is a multi-resolution function.

28. A method as claimed in claim 27, wherein the at least one parameter function is arranged in a hierarchical form from coarse resolution to fine resolution.

29. A method as claimed claim 17, wherein at least one parameter function is stored in a decomposed form, preferably in the form of a wavelet decomposition.

30. A method as claimed claim 17, wherein at least one parameter function is arranged in a compressed form.

31. A method as claimed in claim 30, wherein the at least one parameter function is compressed in a hierarchical form from coarse resolution to fine resolution.

32. A method as claimed in claim 17, wherein the or each transformation has an inverse transformation which maps coordinates within the region of parameter space to coordinates within the associated geological region.

33. A method of updating an earth model as claimed in claim 1, comprising updating at least one transformation while retaining the association with the corresponding geological region and parameter functions.

34. A method of updating an earth model as claimed in claim 1, comprising updating at least one geological region and at least one associated transformation while retaining the association with the corresponding parameter functions.

35. A method of updating an earth model as claimed in claim 1, comprising updating at least one parameter function while retaining the association with the corresponding geological region.

36. A method of generating a representation of at least one parameter using an earth model as claimed in claim 16, comprising the steps of:
selecting a plurality of points in geological space where the parameter is to be represented; and
for each selected point,
identifying the region of geological space containing said point;
transforming the geological space coordinates of said point into parameter space coordinates using the transformation associated with the geological region;
evaluating the parameter function associated with the geological region to produce a parameter value for said point, and
representing the value of said point at a spatial location representing said point.

37. A method as claimed in claim 36, wherein the step of evaluating the parameter function includes evaluating the parameter function at a variable resolution.

38. A software product comprising instructions which when executed by a computer cause the computer to define a plurality of regions of geological space; and for each region of geological space:
define at least one parameter function over a region of parameter space;
define at least one transformation which maps coordinates within the region of geological space to coordinates within the region of parameter space; and
associate said at least one transformation and said at least one parameter function with said region of geological space.

39. A software product as claimed in claim 38, wherein the software product is a physical data carrier.

40. A software product as claimed in claim 38, wherein the software product comprises signals transmitted from a remote location.

41. A method of manufacturing a software product which is in the form of a physical data carrier, comprising storing on the data carrier instructions which when executed by a computer cause the computer to define a plurality of regions of geological space; and for each region of geological space:
define at least one parameter function over a region of parameter space;
define at least one transformation which maps coordinates within the region of geological space to coordinates within the region of parameter space; and
associate said at least one transformation and said at least one parameter function with said region of geological space.

42. A method of providing a software product to a remote location by means of transmitting data to a computer at that remote location, the data comprising instructions which when executed by the computer cause the computer to define a plurality of regions of geological space; and for each region of geological space:
define at least one parameter function over a region of parameter space;
define at least one transformation which maps coordinates within the region of geological space to coordinates within the region of parameter space; and
associate said at least one transformation and said at least one parameter function with said region of geological space.
